(19) United States
(12) Patent Application Publication
(10) Pub. No.: US 2023/0235805 A1
(43) Pub. Date: Jul. 27, 2023

(54) ELASTOMER BUSHING AND ELASTIC BEARING FOR WIND TURBINES

(71) Applicant: EFFBE GmbH, Bad Soden-Salmuenster (DE)

(72) Inventors: Wolfgang Spatzig, Chemnitz (DE); Andreas Kehr, Gruenendeich (DE); Michael Schäddel, Alzenau (DE); Philipp Steigerwald, Partenstein (DE)

(73) Assignee: EFFBE GmbH, Bad Soden-Salmuenster (DE)

(21) Appl. No.: 18/007,176

(22) PCT Filed: Jul. 27, 2021
(86) PCT No.: PCT/EP2021/071046

§ 371 Date: Jan. 27, 2023

(30) Foreign Application Priority Data
Jul. 28, 2020 (DE) 10 2020 119 832.9

(51) Int. Cl. F16F 1/38; F03D 80/70; F16F 1/387

(52) U.S. Cl. CPC F16F 1/3835; F03D 80/70; F16F 1/387; F05B 2240/50; F05B 2280/4003; F05B 2280/5001; F16F 2228/066

(57) ABSTRACT

An elastomer bushing for an elastic bearing of a drive train component of a wind turbine, in particular of a gearbox on a housing, such as a machine carrier, of a wind turbine, may include two half-shells each made of an elastomer part having a Shore hardness of more than 85 Shore A. At least one of the half-shells may have an axial rigidity varying in the direction of its longitudinal axis.

### CROSS REFERENCE TO RELATED APPLICATIONS

This patent application is a U.S. National Stage Application of International Application No. PCT/EP2021/071046, filed Jul. 27, 2021, which claims priority to German Patent Application No. 102020119832.9, filed Jul. 28, 2020, each of which is incorporated herein by reference in its entirety.

### BACKGROUND

### Field

The present disclosure relates to an elastomer bushing for an elastic bearing of a drive train component of a wind turbine. Furthermore, the present disclosure relates to an elastic bearing, in particular a decoupling bearing, for mounting a drive train component, in particular a gearbox, of a wind turbine, in particular on its housing, such as a machine carrier.

### Related Art

In wind turbines, a lot of torque is transmitted from the engine to the gearbox and from there to the generator. To reduce the dynamic loads on the gearbox and support structure, elastic bearings are usually used in the gearbox supports. The elastic bearings include elastic bushings for oscillation and vibration decoupling, which are integrated into the drive train bearing arrangement and are, for example, part of the floating bearing unit in the drive train. The floating bearing unit is made of four elastic bushings and the rolling bearing unit in the gear box. The elastic bushings are connected to the gear box via the torque arm (axle pin) and to the housing or machine carrier via bearing blocks. The elastic bushings are required on the one hand to withstand the high and fluctuating forces acting on the bearing, for example due to wind, and on the other hand to be as soft as possible in the longitudinal direction to ensure a movement clearance of the axle pin.

A typical bearing is known from EP 2 516 883. With regard to the requirements for typical bearings and their installation situation, reference is made to EP 2 516 883. The bearing comprises a clamping bush with an eccentric geometry. The clamping bushing consists of two oval half-shells made of rubber and reinforced or stiffened with metal inserts. Due to the oval geometry, the clamping bushing still has a large dimension in the vertical direction transverse to the longitudinal axis and therefore requires a lot of installation space. It also has a high weight, which is further increased, especially by the metal inserts. Finally, production is difficult due to the combination of elastomer material and metal insert. A further disadvantage is that the adaptation of a desired axial and/or radial rigidity is associated with a high level of effort, in particular due to the matching of elastomer geometry and metal insert.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 is a perspective view of a half-shell of an elastomer bushing according to an exemplary embodiment of the disclosure.

FIG. 2 is a front view of the half shell according to FIG. 1.

FIG. 3 is a side view of the half shell according to FIG. 1 or 2.

FIG. 4 is a perspective view of a half shell of an elastomer bushing according to an exemplary embodiment of the disclosure.

FIG. 5 is a front view of the half shell according to FIG. 4.

FIG. 6 is a side view of the half shell according to FIG. 4 or 5.

FIG. 7 is a perspective view of a half shell of an elastomer bushing according to an exemplary embodiment of the disclosure.

FIG. 8 is a front view of the half shell according to FIG. 7.

FIG. 9 is a side view of the half shell according to FIGS. 7 and 8, respectively.

FIG. 10 is a side view of an elastic bearing according to an exemplary embodiment of the disclosure.

FIG. 11 is a sectional view of the elastic bearing according to FIG. 10.

FIGS. 12a-12f are schematic sectional views illustrating the assembly of an elastic bearing according to an exemplary embodiment of the disclosure.

FIG. 13 is a side view of a half shell of an elastomer bushing according to an exemplary embodiment of the disclosure.

FIG. 14 is a perspective view of the half shell of FIG. 13.

FIG. 15 is a side view of a half shell of an elastomer bushing according to an exemplary embodiment of the disclosure.

FIG. 16 is a perspective view of the half shell of FIG. 15.

FIG. 17 is a side view of a half shell of an elastomer bushing according to an exemplary embodiment of the disclosure.

FIG. 18 is a perspective view of the half shell of FIG. 17.

FIG. 19 is a side view of a half shell of an elastomer bushing according to an exemplary embodiment of the disclosure.

FIG. 20 is a perspective view of the half shell of FIG. 19.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

An object of the present disclosure to improve the disadvantages of the known prior art, in particular to provide an elastomer bushing as well as an elastic bearing for wind turbines, which has a lower weight, requires less installation space and/or can be adjusted more flexibly with regard to axial and/or radial rigidity.

Accordingly, an elastomer bushing for an elastic bearing of a drive train component of a wind turbine is provided. For example, an elastomer bushing for an elastic bearing of a transmission on a housing, such as a machine carrier, of a wind turbine is provided. Elastic bearings are used in wind turbines to absorb the dynamic loads acting on the drive train component and the housing. By means of the elastomer bushing, vibration and/or oscillation damping as well as decoupling can take place. With regard to the basic installation situation of the elastomer bushing or the elastic bearing, reference is made to EP 2 516 883, the contents of which are incorporated by reference in the present application.

The elastomer bushing according to the disclosure comprises two half-shells, each of which is made from an elastomer piece, in particular monolithic, with a Shore hardness of more than 85 Shore A. The Shore hardness is a material parameter for elastomers and plastics specified in the standards DIN EN ISO 868, DIN ISO 7619-1 and ASTM D 2240-00. The half-shells can be made of the same material and/or have the same dimension. In an assembly state in the elastic mount, the two half-shells can rest on each other on the end face to form a lead-through, in particular a cylindrical lead-through, for example for a fastening part of the drive train component, such as the torque arm or the axle pin. A wall thickness of the half-shells can be dimensioned significantly smaller than their circumferential extent. In cross section, the half-shells can have a c-shape or a half-ring shape. The selected Shore hardness of the half-shells, in particular of the elastomer piece material, ensures the necessary load-bearing capacity, whereby, for example, up to four times higher loads can be absorbed with comparable deformation compared with standard rubber-metal elastomer bushings, while at the same time it is possible to dimension the elastomer bushings significantly smaller. Thus, a lower component weight, lower component costs and smaller component dimensions can be achieved.

According to the disclosure, at least one half-shell, in particular both half-shells, has an axial rigidity that varies in the direction of its longitudinal axis. For example, the at least one half-shell is designed and/or constructed in such a way that at least two axial sections of the half-shell are formed which have different axial rigidity. Thus, on the one hand, the considerable load requirements, in particular in the radial direction, can be met and, at the same time, the axial rigidity can be set in dependence on of the specific requirements. For example, it is thus possible to design the axial rigidity of the elastomer bushing to be also significantly lower than the radial rigidity. In particular, the inventors of the present disclosure have succeeded in being able to set the axial rigidity independently of the radial rigidity, at least to a certain extent. By flexibly designing the axial or radial rigidity of the elastomer bushing, further savings can be achieved in terms of material requirements, installation space and thus also costs. Axial rigidity can be understood as the resilience of the elastomer bushing, in particular the half-shell, against elastic deformation caused by an external force application, in particular in the direction of the longitudinal axis, for example a shear load or elongation load. In the present context, radial rigidity can be understood as the resilience of the elastomer bushing or the half-shells against elastic deformation in the event of a force application transverse, in particular radial, to the longitudinal axis. The varying axial rigidity can be achieved, for example, by at least one half-shell being segmented, in particular having different radial wall thicknesses along the longitudinal axis. Furthermore, it is possible to make the radial rigidity dependent on the orientation, whereby, for example, the radial rigidity in the horizontal direction can be greater or less than the radial rigidity in the vertical direction.

In an exemplary embodiment of the present disclosure, at least one elastomer part comprises polyurethane. For example, it is polyurethane polyester or polyester Urelast rubber. Preferably, urethane is used. The aforementioned materials for the elastomer piece have proven to be particularly advantageous, especially because of their high load-bearing capacity, high tensile strength and very good wear behavior. Above all because of the high load-bearing capacity, it is possible to dimension the elastomer bushing smaller. This results in advantages in terms of installation space, material requirements and costs. Urelast is generally a cast elastomer.

According to a further exemplary embodiment of the elastomer bushing according to the disclosure, the half-shells each have a central axis which are oriented concentrically to one another when the half-shells rest on one another and/or in the mounted state in the bearing, in particular in the operating state. Due to the concentric arrangement, there are above all further advantages in terms of installation space. To establish different rigidities in different directions, it is no longer necessary to configure the half-shells oval or elliptical, for example, and/or to arrange them eccentrically to one another in the assembled state in the elastic bearing. In the assembled state, the elastomer part half-shells form an essentially annular shape, with an in particular cylindrical lead-through for a fastening part of the drive train component, such as the torque arm or the axle pin, as well as an at least approximately round outer circumference, which in the assembled state is contacted in the bearing, in particular in the operating state, by two bearing block parts, in particular is completely surrounded and/or in particular is received in a clamping manner.

In an exemplary further development of the elastomer bushing according to the disclosure, its radial rigidity transverse to the longitudinal axis is greater than its axial rigidity in the longitudinal axis direction. For example, the axial rigidity is less than 10%, in particular less than 5% or less than 2%, of the radial rigidity. The stated ratios have proven to be particularly advantageous with respect to the specific requirements in elastic bearings in wind turbines for mounting the drive train component on the housing, in particular machine carrier, of the wind turbine. When using the elastomer bushing in floating bearings, a particularly low axial rigidity is desirable. Furthermore, it is possible to make the radial rigidity dependent on the orientation, whereby, for example, the radial rigidity in the horizontal direction can be greater or less than the radial rigidity in the vertical direction. For example, the radial rigidity in the different directions can differ by 5% or by 8% or even by more than 10%.

According to another aspect of the present disclosure, which is combinable with the preceding aspects and exemplary embodiments, there is provided an elastomer bushing for an elastic bearing of a drive train component of a wind turbine. For example, the elastomer bushing is an elastomer bushing for an elastic bearing of a transmission on a housing, such as a machine carrier, of a wind turbine. Elastic bearings are used in wind turbines to absorb the dynamic loads acting on the drive train component and the housing. By means of the elastomer bushing, vibration and/or oscillation damping as well as decoupling can take place. With regard to the basic installation situation of the elastomer bushing or the elastic bearing, reference is made to EP 2 516 883, the contents of which are incorporated by reference in the present application.

The elastomer bushing according to the disclosure comprises two half-shells, each of which is made from an elastomer part, in particular monolithic, with a Shore hardness of more than 85 Shore A. Alternatively, the Shore hardness of the elastomer pieces can be at least 80 Shore A. Alternatively, the Shore hardness of the elastomer pieces may be at least 80 Shore A. The Shore hardness is a material parameter for elastomers and plastics that is specified in the standards DIN EN ISO 868, DIN ISO 7619-1 and ASTM D 2240-00. The half-shells can be made of the same material and/or have the same dimension. In an assembly state in the elastic mount, the two half-shells can rest on each other on the end face to form a lead-through, in particular a cylindrical lead-through, for example for the torque arm. A wall thickness of the half-shells can be dimensioned significantly smaller than their circumferential extent. In their cross section, the half-shells can have a c-shape or a half-ring shape. The selected Shore hardness of the half-shells, in particular of the elastomer piece material, ensures the necessary load-bearing capacity, whereby, for example, up to four times higher loads can be absorbed compared with standard rubber-metal elastomer bushings, while at the same time it is possible to dimension the elastomer bushings significantly smaller. In this respect, a lower component weight, lower component costs and smaller component dimensions can be achieved.

According to the further aspect of the disclosure, at least one half-shell, in particular the half-shell with the varying axial rigidity, has at least two support webs arranged at a distance from one another in the longitudinal direction and/or transversely, in particular perpendicularly thereto. The support webs project from an outer or inner circumference of the half-shell such a way that a deflection space is formed between each two support webs. The deflection space can be a groove or a recess, for example. The support webs arranged on the outer circumference, hereinafter also referred to as outer support webs, are in load-bearing contact with the bearing parts of the elastic bearing surrounding the elastomer piece half-shells on the outside in the mounted state in the bearing, in particular in the operating state. Support webs provided on the inner circumference of the half-shell, hereinafter also referred to as inner support webs, come into load-bearing contact with the drive train component, in particular its torque arm or axle pin, which is accommodated by a lead-through limited by the inner circumference of the half-shells, in the operating state, i. e. in the mounted state in the bearing. Support webs arranged at the same axial height of the elastomer bushing with respect to its longitudinal axis and separated from each other by a deflection space, such as a groove or a recess, can be referred to as circumferential support webs. Support webs arranged at the same circumferential height of the elastomer bushing with respect to its longitudinal axis and separated from each other by a deflection space, such as a groove or a recess, can be referred to as axial support webs. In this way, it is possible, in particular by flexibly designing the geometry of the elastomer bushing, to flexibly adjust the spring rigidity of the elastomer bushing with respect to all spatial axes, in particular to be able to respond to any load requirements. The inventors of the present disclosure have found out that the axial rigidity as well as the radial rigidity can be specifically adjusted on the one hand in the horizontal direction and on the other hand in the vertical direction by means of the support web yield space structure of the elastomer bushing.

According to an exemplary further development of the elastomer bushing according to the disclosure, the support webs are set up to yield to the elastomer bushing in the longitudinal direction and/or transversely thereto into an adjacent yielding space in the event of a load, in particular in the longitudinal direction and/or transversely thereto. In this way, it is possible to adjust the axial rigidity and/or the radial rigidity, for example depending on the expected loads, the dimensioning of the wind turbine and/or the power of the wind turbine. The axial rigidity and/or the radial rigidity can be adjusted, for example, by dimensioning the support webs and/or the grooves. In general, the higher the degree of deflection of the support webs into adjacent deflection spaces, the lower the rigidity of the half-shell in this direction.

In a further exemplary embodiment of the elastomer bushing according to the disclosure, the support webs have a rectangular shape or a conical shape in cross section. For example, it is possible for the support webs to taper in the radial direction, in particular continuously. Discontinuous tapering is also conceivable. The cross-sectional shape of the support webs can also be used to selectively adjust their ability to deflect into the adjacent grooves in order to achieve a specific rigidity in this direction.

According to a further exemplary further development of the elastomer bushing according to the disclosure, at least one support web is segmented in the circumferential direction and/or subdivided into circumferential sections. The circumferentially segmented and/or subdivided sections of the support web may be referred to as circumferential support webs. Here, the at least one support web may be segmented or subdivided in the circumferential direction such that at least 2, 3 or 4 circumferential support webs are formed. The circumferential support webs may extend in the circumferential direction by substantially the same circumferential dimension. Furthermore, two respective adjacent circumferential support webs may be separated from one another in the circumferential direction by a recess, in particular a rectilinear recess and/or a recess oriented in the longitudinal direction, which forms the deflection space. The recesses can also be curved at least in sections.

According to an exemplary further development of the elastomer bushing according to the disclosure, the circumferential support webs are set up to yield in each case in an adjacent recess in the circumferential direction when a load is applied to the elastomer bushing, in particular transversely to the longitudinal direction. With regard to the recess and the deflection of the circumferential support webs into it, the comments on the groove and the deflection of the support webs into it apply in an analogous manner. Segmentation of the support webs in the circumferential direction allows additional adjustment of the rigidity of the elastomer bushing or the corresponding half-shell in the circumferential direction, in particular independently of the axial rigidity or without significantly influencing the axial rigidity.

In a further exemplary embodiment of the elastomer bushing according to the disclosure, at least one half shell comprises an anti-rotation device. The anti-rotation device is designed to prevent rotation of the elastomer bushing about the axial direction in the operating state of the elastic bearing. For example, the anti-rotation device is implemented by pinning, bonding or by a radial projection cooperating with a bearing block part of the bearing. For example, the radial projection is a shoulder projecting radially from the outer circumference of the half-shell, which is located between the bearing block parts in the bearing in the mounted state. For example, the radial protrusion is clamped by the two bearing block parts. For example, the radial protrusion may engage at least one bearing block member in a positive locking engagement such that any relative rotation between the elastomer bushing and the bearing block member is prevented.

According to an exemplary further development of the elastomer bushing according to the disclosure, the half-shells have a c-shaped cross-section. The radial projection can be arranged in the region of an open end of the c-shaped cross section, in other words in the region of an open-end section of the half-shell. For example, both half-shells have a radial projection, in particular formed in the same shape, which can be arranged essentially at the same position of the respective half-shell, so that the radial projections are opposite one another in the operating state, in particular rest on one another and/or are jammed against one another by the bearing block parts.

In another exemplary embodiment of the present disclosure, at least one half-shell has a radial rigidity that varies transversely to the longitudinal axis. It has been found that the loads in the radial direction on the elastomer bushing are also not completely evenly distributed in the circumferential direction. The inventors of the present disclosure have found that there are areas of increased stress. By selectively strengthening in the highly stressed areas and/or selectively relatively weakening in the less highly stressed areas, it is possible to achieve further savings in terms of cost, material and installation space. The intelligent design of the elastomer bushing is supported by the preferred choice of material, which on the one hand ensures flexible manufacture and on the other hand is very highly stressable.

According to an exemplary further development of the elastomer bushing according to the disclosure, the support webs have a varying radial height in the circumferential direction and/or in the longitudinal direction. For example, at least one support web has a radial height that varies in the circumferential direction. For example, the radial height of the at least one support web, in particular of all support webs, decreases towards an open-end section of the half-shell and/or towards an apex of the half-shell, in particular continuously. It has been found that lower radial loads occur in the region of the 3/9 o'clock position and also the 6 o'clock position, so that material can be saved in these regions in order to lower the rigidity in this respect. Alternatively, or additionally, further material can be saved by varying the radial height in the longitudinal direction of the elastomer bushing, in particular by deliberately adjusting the radial height of the individual support webs in the longitudinal direction depending on an anticipated load. For example, near the end regions in the longitudinal direction and/or in the central middle region, the support webs can have a higher radial dimension than in intermediate regions. Furthermore, it is possible to form groups of support webs with the same radial height and to alternate groups of different radial heights along the longitudinal axis.

According to a further exemplary embodiment, the support webs have a recess, in particular a concave recess, in the region of a vertex of the c-shaped half shells. In other words, the recess is at the 6 o'clock position. In the assembled state in the elastic bearing, the recess points downwards in the vertical direction.

In a further exemplary embodiment of the elastomer bushing according to the disclosure, one half-shell has a greater radial rigidity transverse to the longitudinal axis than the other half-shell. For example, the rigidity deviation of the two half-shells from each other is between 0.1% and/or at most 5%.

Furthermore, for example, an axial dimension of the deflection spaces and/or the support webs can vary in the course of the longitudinal direction. One advantage of the elastomer bushing according to the disclosure is, among other things, that the elastomer bushing can be specifically adapted to external conditions, such as anticipated loads, in order, on the one hand, to provide the required rigidity and stability and, on the other hand, to create a design that is as cost-effective as possible, in particular one that is material-conscious and/or reduced.

According to a further exemplary embodiment of the elastomer bushing, the support-web/deflection-space-sequence comprises at least three, in particular at least five, seven, nine, eleven or at least 13 support webs. It should be understood that the number of deflection spaces is one less compared to the number of support webs. Thus, a lamellar-like structure can be formed. For example, the plurality of support webs are arranged uniformly distributed in the longitudinal direction. However, the distances between two adjacent support webs, i. e. the axial dimension of the deflection spaces, may also vary. In this case, the axial dimension of the deflection spaces can be smaller than the axial dimension of the support webs. For example, the support-web/deflection-space-sequence can be formed in such a way that the ratio of deflection-space to support-web is in the range from 1/5 to 1/10.

In a further exemplary embodiment of the elastomer bushing according to the disclosure, the at least one half-shell has multiple slits on its outer circumference. For example, at least three, in particular at least five, seven, nine, eleven or at least 13 slits can be made in the elastomer piece body. In this case, the slits can be arranged at a particularly uniform distance from one another in the longitudinal direction. Alternatively, or additionally, the slots may be dimensioned such that mutually facing and longitudinally oriented slot surfaces of two elastomer piece webs each separated by means of a slot are in contact with each other in an undeformed state of the elastomer bushing. Alternatively, or additionally, the deflection spaces can be dimensioned in the longitudinal direction in such a way that two respectively adjacent support-webs are in contact with each other in an undeformed state of the elastomer bushing. In other words, an axial dimension of the slots or the deflection spaces may be approximately 0 mm. The basic idea of these embodiments of the elastomer bushing according to the disclosure is that the half-shells actually consist mostly of solid material or are made of a solid body and are sharply slotted on the outside, so that longitudinally distributed support webs or elastomer piece webs result, contact each other in an initial state of the elastomer bushing. When the elastomer bushing is deformed, the support-webs or elastomer piece webs deform substantially simultaneously.

According to a further aspect of the present disclosure, which can be combined with the preceding aspects and exemplary embodiments, an elastic bearing, in particular a decoupling bearing, for supporting a drive train component, in particular a gearbox, of a wind turbine, in particular on its housing, such as its machine carrier, is provided. For example, this is an elastic bearing of a gearbox on a housing, such as a machine carrier, of a wind turbine. Elastic bearings are used in wind turbines to absorb the dynamic loads acting on the drive train component and the housing. By means of the elastic bearing, vibration and/or oscillation damping as well as decoupling can take place. With regard to the basic installation situation of the elastic bearing, reference is made to EP 2 516 883, the contents of which are incorporated by reference in the present application.

The elastic bearing according to the disclosure comprises an elastomer bushing formed according to one of the exemplary aspects or exemplary embodiments described above and two bearing block parts for receiving the elastomer bushing, in particular in a clamping manner. The bearing block parts are to be arranged or disposed on the housing side and are decoupled or damped from each other by the elastic bearing with respect to vibration and/or oscillation. For this reason, the elastic bearing can also be referred to as a decoupling bearing.

According to a further aspect of the present disclosure, which can be combined with the preceding aspects and exemplary embodiments, an elastic bearing, in particular a decoupling bearing, for mounting a drive train component, in particular a gearbox, of a wind turbine, in particular on its housing, such as its machine carrier, is provided. For example, this is an elastic bearing of a gearbox on a housing, such as a machine carrier, of a wind turbine. Elastic bearings are used in wind turbines to absorb the dynamic loads acting on the drive train component and the housing. By means of the elastic bearing, vibration and/or oscillation damping as well as decoupling can take place. With regard to the basic installation situation of the elastic bearing, reference is made to EP 2 516 883, the contents of which are incorporated by reference in the present application.

The elastic bearing according to the disclosure comprises an elastomer bushing formed in particular according to one of the exemplary aspects or exemplary embodiments described above and two bearing block parts for receiving the elastomer bushing, in particular in a clamping manner. The elastomer bushing comprises two half-shells, each made of an elastomer piece having a Shore hardness greater than 85 Shore A. According to this aspect, the elastomer bushing is configured such that an axial movement clearance of the elastomer bushing in the direction of its longitudinal axis relative to the bearing block components or relative to a mounting component, such as a torque arm or an axle pin, of the drive train component that may be received by the elastomer bushing is permitted when a load is applied, particularly in the longitudinal direction, to the resilient bearing. For example, the axial movement clearance is at least 1 mm and at most 50 mm, in particular between 1 mm and 40 mm, 30 mm, 20 mm or 10 mm. An axial movement clearance in the range of 2 mm to 3 mm has proven to be advantageous.

The elastomer bushing may furthermore be configured and/or dimensioned in such a way that a relative movement clearance transverse to the longitudinal axis, in particular in the radial direction, relative to the bearing block parts or relative to a fastening part possibly accommodated by the elastomer bushing, such as a torque support or an axle pin, of the drive train component is less than the axial relative movement clearance, in particular is prevented.

According to another aspect of the present disclosure, which is combinable with the preceding aspects and exemplary embodiments, there is provided a wind turbine having a resilient bearing according to one of the aspects previously described.

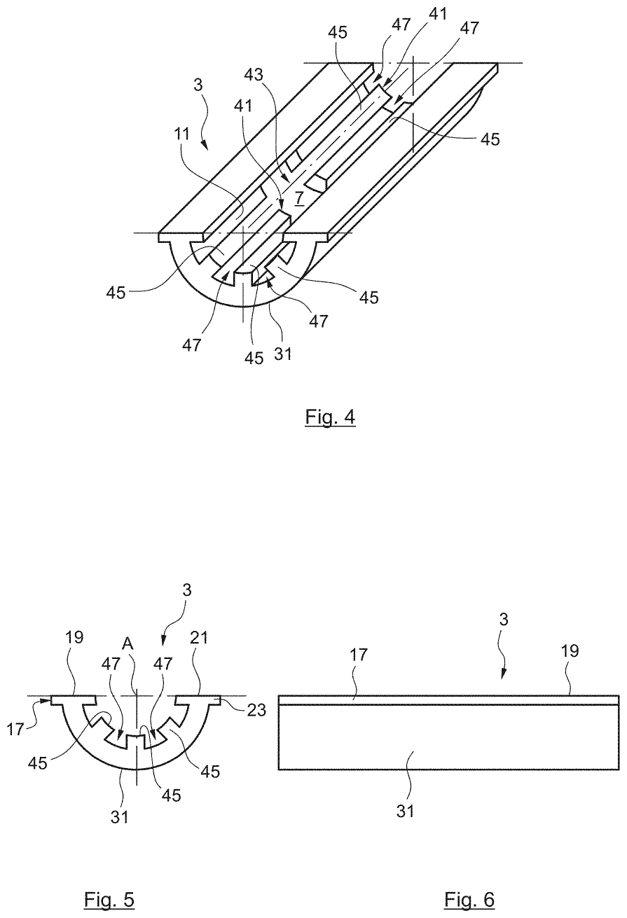

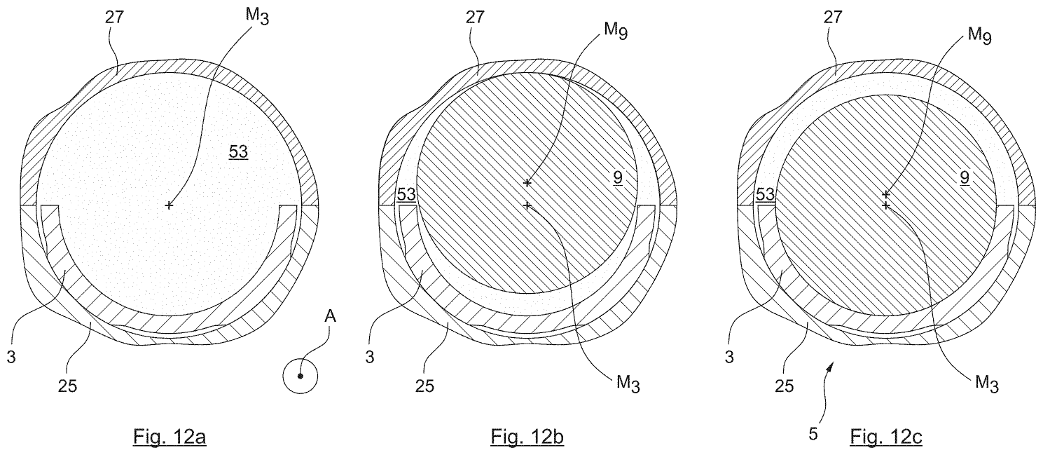

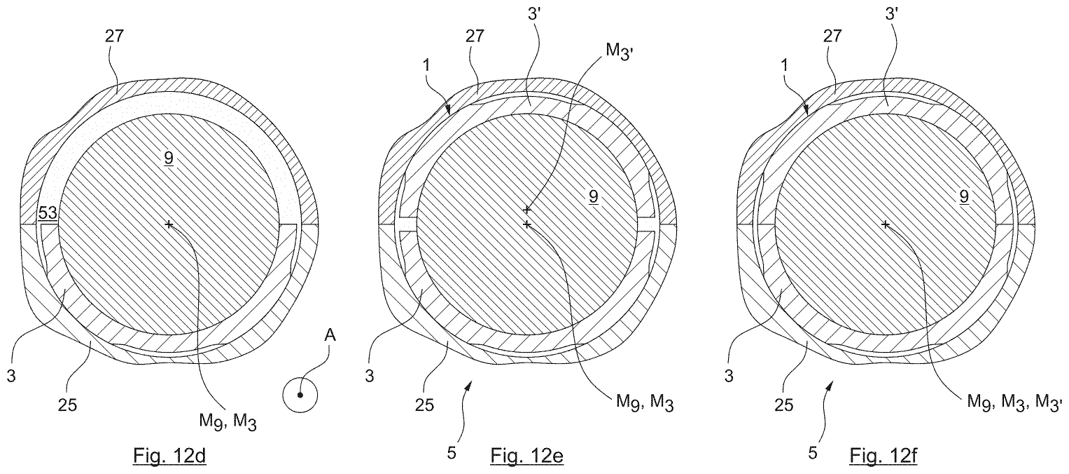

With reference to FIGS. 1 to 9 and 13 to 20, various embodiments of elastomer bushings according to the disclosure, generally provided with the reference numeral 1, are described. In each of FIGS. 1 to 9 and 13 to 20, a half-shell, generally provided with the reference numeral 3, of the respective elastomer bushing 1 is illustrated. It can be assumed that the second half-shell 3 associated with the half-shell 3 shown to form the elastomer bushing 1 (FIG. 10) may be formed essentially the same way. In this respect, the explanations made with respect to the half-shell 3 shown can be transferred to the second half-shell 3′ not shown in FIGS. 1 to 9. With reference to FIGS. 10 to 12f, exemplary embodiments of an elastic bearing according to the disclosure, which is generally provided with the reference numeral 5, are described in more detail, with reference to FIGS. 12a to 12f illustrating the assembly of the elastic bearing 5. For the following description of the exemplary embodiments illustrated in the figures, it may be assumed that the half-shell 3 of the elastomer bushing 1 is made of an elastomer piece having a Shore hardness of more than 85 Shore A, preferably using the material polyurethane.

Referring to the first embodiment example of FIGS. 1 to 3 of a half-shell 3 of an exemplary embodiment of an elastomer bushing 1 according to the disclosure, the basic structure of the half-shell 3 is apparent. The half-shell 3 has a semicircular shape in cross-section. The half-shell 3 has a sectionally constant cross-section in the direction of longitudinal extension, i. e. along the longitudinal axis A. The half-shell 3 is concavely curved and has an open side which is to be assigned to and face the second, not shown, half-shell 3′.

The half-shell 3 bounds a semi-cylindrical, hollow inner space 7, which serves to accommodate a connecting part of the drive train component (not shown), such as a torque arm (axle pin 9 in see FIG. 10). An inner wall 11 of the half-shell 3 bounding the inner space 7 is uniformly curved along the longitudinal axis A and extends from one end-face semi-cylindrical opening 13 to an opposite end-face semi-cylindrical opening 15 so that, for example, the axle pin 9 can protrude from the half-shell 3 at both end-faces.

In the region of an open-end section 15 of the half-shell 3, the half-shell 3 has flat bearing surfaces 19, 21 extending in the direction of the longitudinal axis A, which come into contact with, in particular, complementarily shaped bearing surfaces of the further half-shell not shown in the assembled state in the elastic mount 1. Furthermore, in the region of the end section 17, a radial projection 23 projecting transversely to the longitudinal axis direction A over an outer circumference of the half-shell 3 is arranged, which forms an anti-rotation device in the elastic bearing 1. The anti-rotation device is achieved by means of the radial projection 23 by positive engagement in a corresponding recess in the associated bearing block parts 25, 27 (FIG. 10) of the elastic bearing 1 or by an arrangement of the radial projection 23 in the assembled state in the elastic bearing 1 in such a way that a relative rotation of the elastomer bushing 1 relative to the bearing block parts 25, 27 surrounding the half-shells 3 is prevented. For example, the radial projection 23 can be arranged in the contact or separation area between the two bearing block parts 25, 27, in particular be clamped by the bearing block parts 25, 27.

The half-shell 3 has an axial rigidity varying in the direction of its longitudinal axis A and a radial rigidity varying transversely to the longitudinal axis A. In FIGS. 1 to 3, the half-shell 3 has three support webs 29 arranged at a distance from one another in the direction of the longitudinal axis A, in particular of identical design, which extend away from an outer circumference 31 transversely to the direction of the longitudinal axis A, in particular in the radial direction, and project from the outer circumference 31.

A circumferentially oriented groove 31 forming a deflection space is formed between two respectively adjacent support webs 29. The support webs 29 can be dimensioned and/or curved in the circumferential direction in such a way that a radius of curvature of an imaginary outer contour line of the support webs 29 has the same radius of curvature as the outer circumference 31.

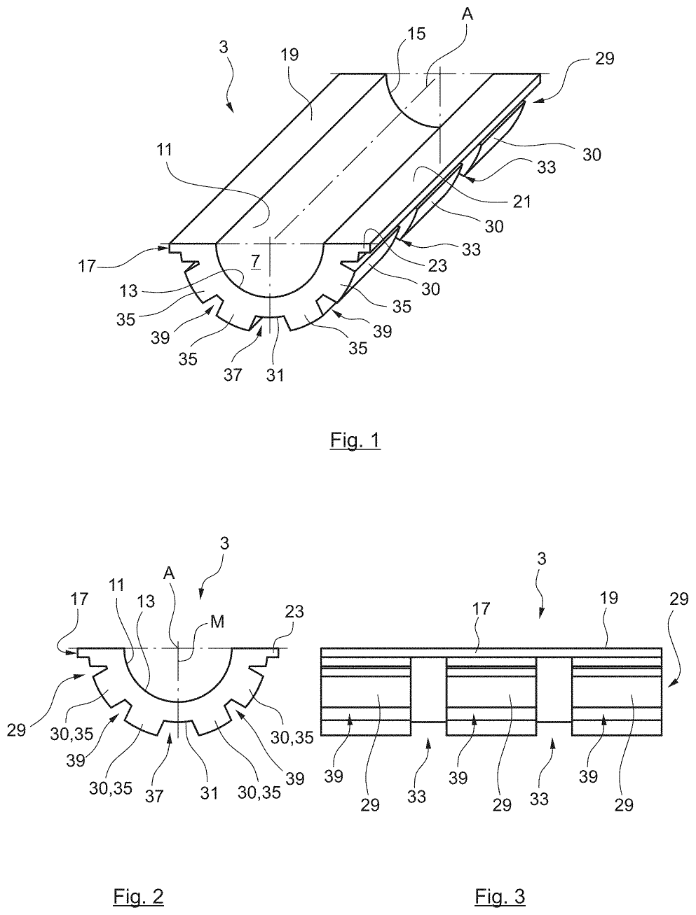

In FIGS. 1 to 3, three axial support webs 30 are provided which form two grooves 33 between them. When a load or force is applied from outside, in particular in longitudinal axis direction A, to the elastomer bushing 1 or the half-shell 3, the axial support webs 30 can yield into the adjacent grooves 33, in particular elastically, or deform in such a way that the axial support webs 30 at least partially fill the grooves 33. The yielding of the axial support webs 30 into the adjacent grooves 33 has the effect, on the one hand, that the half-shell 3 has a lower axial rigidity with respect to the radial rigidity. Furthermore, the variation of the axial rigidity in longitudinal axis direction A is to be understood in such a way that the half-shell 3 can have a radial wall thickness varying along the longitudinal axis A. In the event of an external load, in particular in the operating state in the assembled elastic bearing 5, the axial support webs 30 can deflect into the adjacent grooves 33, so that a relative movement clearance between the elastomer bushing 1 and the two bearing block parts 25, 27 or, if applicable, the axle pin 9 is permitted in the longitudinal direction A. As can be seen in FIGS. 1 to 3, the half-shell 3 is of mirror-symmetrical design with respect to a center plane M. As can be seen in particular in FIG. 2, the axial support webs 30 have a substantially rectangular cross-sectional shape, so that the adjacent deflection grooves 33 have a substantially trapezoidal shape (FIG. 2).

In particular, it can be seen from FIGS. 1 and 2 that the support webs 29 are segmented in the circumferential direction. This means that the support webs 29 are divided into circumferential support webs 35 in the circumferential direction. In the embodiment according to FIGS. 1 to 3, four, in particular equally dimensioned, circumferential support webs 35 are formed per support web 29. The circumferential support webs 35 are designed to deflect in the circumferential direction into an adjacent recess 37, 39 forming a deflection space in the event of a load, in particular in the longitudinal axis direction A. In particular, it can be seen from FIG. 2 that a substantially central recess 37 is of larger dimensions in the circumferential direction than the two adjacent recesses 39. In this respect, a possibility of deformation of the circumferential support webs 35 adjacent to the central recess 37 is greater than a possibility of deformation of the two outer circumferential support webs 35 bounding the narrower recesses 39. In general, it should be understood that a support web section can realize both a circumferential support web as well as an axial support web. This is particularly the case when the support web 29 is segmented in both axial direction and circumferential direction.

The design of the half-shell 3 of FIGS. 4 to 6 of a further exemplary elastomer bushing 1 according to the disclosure differs from the design according to FIGS. 1 to 3 essentially by the realization of the varying axial and/or radial rigidity. In all other respects, reference can be made to the preceding explanations.

As can be seen from a comparison of FIGS. 4 to 6 with FIGS. 1 to 3, in the embodiment according to FIG. 6, the mechanism for allowing the relative axial movement clearance between the elastomer bushing 1 and the further component, namely the attachment part of the drive train component, such as the axle pin 9, is arranged on the inner circumference or inner wall 11. The outer circumference 31 is continuous in shape and forms a substantially cylindrical outer contour. In the embodiment of FIGS. 4 to 6, support webs 41 are arranged on the inside in the region of the inner space 7. The inner support webs 41 are segmented or subdivided in both the axial direction and the radial direction to form circumferential support webs 45 and to form axial support webs 42. The axial support webs 42 extend substantially in the longitudinal axis direction A and project radially inwardly from the inner circumference 11 into the inner space 7. A groove 43 forming a deflection space is formed between two respectively adjacent axial support webs 42. Analogously to the mode of operation of the outer-side axial support webs 29 on the elastomer bushing 3, in particular the outer-side axial support webs 30, the inner-side axial support webs 42 can yield into the respective adjacent inner-side groove 43 in the event of a load from the outside, in particular in longitudinal axis direction A. According to FIG. 4, it can be seen that in the exemplary embodiment two axial support webs 42 are provided, which are arranged at a distance from one another in longitudinal axis direction A and which delimit a deflection groove 43, which is arranged in particular centrally with respect to the longitudinal extent of the half-shell 3 and is essentially completely circumferential in the circumferential direction.

Furthermore, corresponding to the design of the outer-side support webs 29, the inner-side support webs 41 are subdivided in the circumferential direction into circumferential support webs 45, for example into three circumferential support webs 45. In this respect, between each two adjacent circumferential support webs 45 there are essentially rectilinear recesses 47 extending in the direction of the longitudinal axis A, into which in turn the circumferential support webs 45 can yield when a load and/or force is applied from the outside. The circumferential support webs 45 have a substantially constant cross-section in the longitudinal axis direction A. The same applies to the adjacent yielding recesses 47.

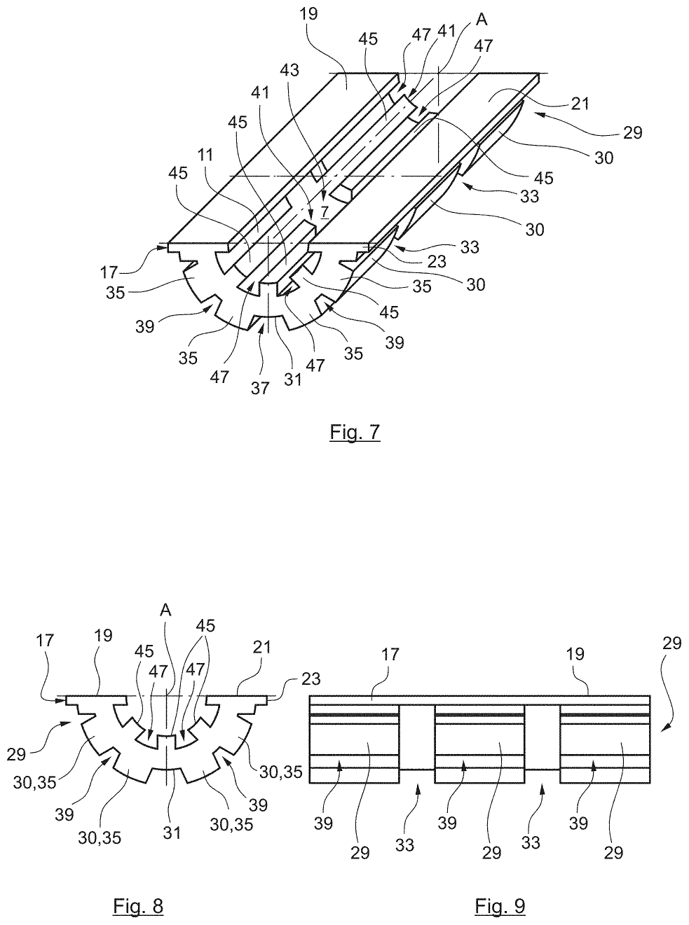

With reference to FIGS. 7 to 9, an embodiment of a half-shell 3 is shown which is to be understood as a combination of the design and structural features of the half-shells of the two embodiments of FIGS. 1 to 3 and 4 to 6, respectively. This means that the half-shell 3 according to FIGS. 4 to 6 has both the inner-side motion clearance mechanism and the outer-side motion clearance mechanism, both in the axial direction and in the radial direction. With regard to the respective design details, reference can be made to the preceding description. The half-shell 3 of FIGS. 7 to 9 therefore makes it possible, in case a load is applied, in particular in the longitudinal direction A, onto the elastomer bushing 1 in its mounted state in an elastic bearing 5, the elastomer bushing 1 moves axially in the longitudinal direction A both relative to the outside bearing block parts 25, 27 and relative to the inner axle pin 9.

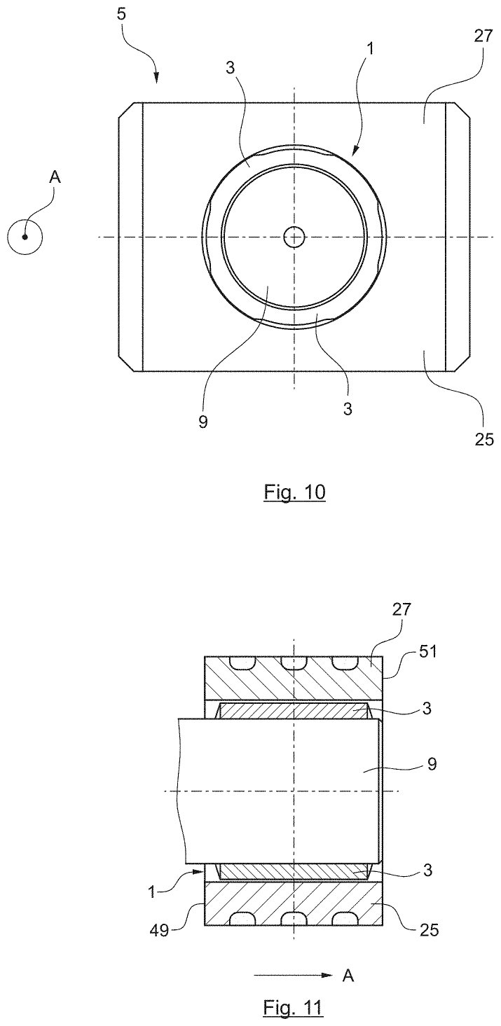

With reference to FIGS. 10 and 11, an exemplary design of an elastic bearing 5 according to the disclosure is shown. FIG. 10 shows an assembly state of the elastic bearing 5 from the side. In the center, on the inside, there is a fastening part of a drive train component designed as an axle pin 9, for example of a gearbox of the wind turbine, which is enclosed and surrounded on the outside by an elastomer bushing 1, for example according to the disclosure. The elastomer bushing 1 is in turn surrounded or enclosed by two bearing block parts 25, 27, which are to be understood on the wind turbine side.

The bearing 5 according to the disclosure, which can also be referred to as a decoupling bearing if it is designed in such a way that it can decouple oscillations and/or vibrations between the drive train component and the housing of the wind turbine, serve to mount the drive train component on the housing of the wind turbine, in particular its machine carrier, in a vibration-decoupling and/or vibration-damping manner. Namely, by means of the elastomer bushing 1, in particular according to the disclosure, vibration damping and/or decoupling between said components is made possible. In the assembled state, as illustrated in FIG. 10, it is possible for the elastomer bushing, when subjected to an external load on the elastic bearing, to perform an axial relative movement clearance in the direction of its longitudinal axis A and/or a radial relative movement clearance transverse to the longitudinal axis A relative to the bearing block parts 25, 27 or the axle pin 9.

FIG. 11 shows a sectional view of the elastic bearing 1 from FIG. 10. It can be seen from FIG. 11 that the axle pin 11 extends beyond one end face 49 of the bearing, namely up to the drive train component (not shown). At the opposite end face 51, the axle pin is flush with the bearing block parts 25, 27. FIG. 11 also shows that an axial dimensioning of the elastomer bushing, in particular its half shells 3, is smaller than the axial dimensioning of the bearing block parts 25, 27.

When assembling the elastic bearing 5 according to the disclosure, a half shell 3 of the elastomer bushing 1 is first inserted between the two bearing block parts 25, 27, in particular onto the lower bearing block part 25 (FIG. 12a). Then the fastening part of the drive train component, in this case the axle pin 9, is also inserted into the bearing space 53 limited by the bearing block parts 25, 27 (FIG. 12b). It can be seen from FIG. 12b that the center point M3 of the lower half shell 3 is offset from one another, in particular in the vertical direction with respect to its center point M9 of the axle pin 9. The axle pin 9 is then set down in the vertical direction and placed on the lower half shell 3. This results in a significantly smaller center offset between the axle pin 9 and the lower half shell 3 (FIG. 12c). Subsequently, the axle pin 9 and the lower half shell 3 are aligned with each other as far as possible, in particular centered with respect to each other, so that there is only a slight center offset (not shown in FIG. 12d). The center points M3 and M9 are aligned by pretensioning or bracing the lower half shell 3. After pretensioning the lower half shell 3, the second half shell 3, in particular the upper half shell 3′, can be inserted into the bearing chamber 53. As indicated in FIG. 12e, there is a slight center offset, in particular oriented in the vertical direction, between axle pin 9 or lower half-shell 3 and the upper half-shell 3′. By finally relaxing the elastic bearing 5, the two half shells 3, 3′ and the axle pin 9 can be aligned with each other so that there is essentially no longer any center offset (FIG. 12f). Axle pin 9, lower and upper half shells 3, 3′ are arranged essentially concentrically to each other. This results in the most space-saving elastic bearing 1 possible.

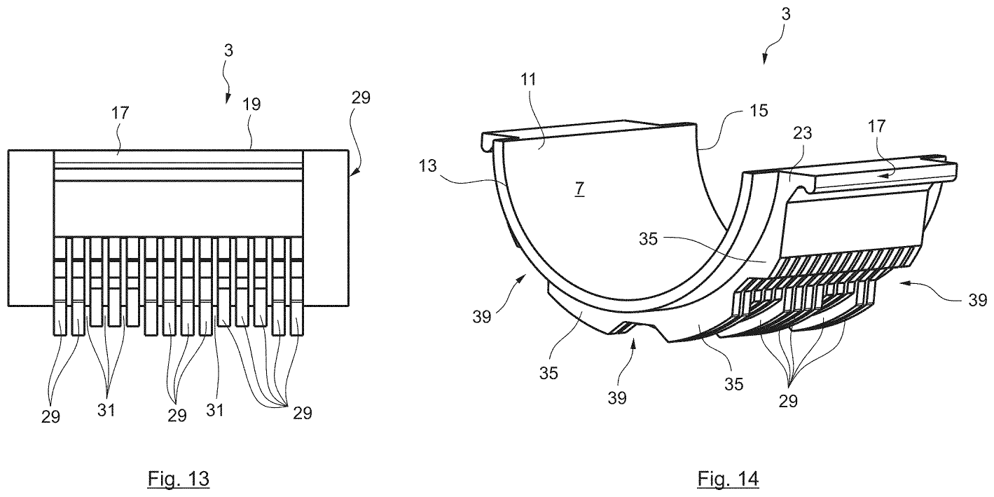

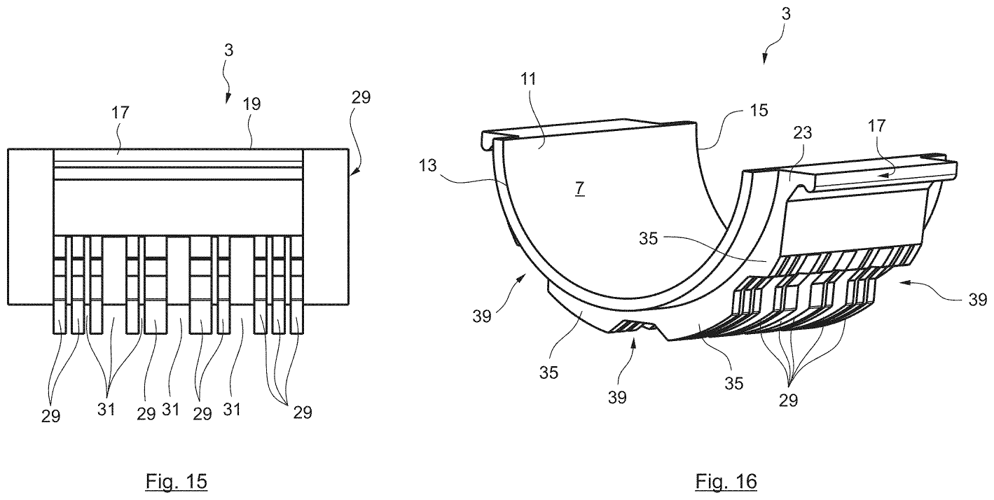

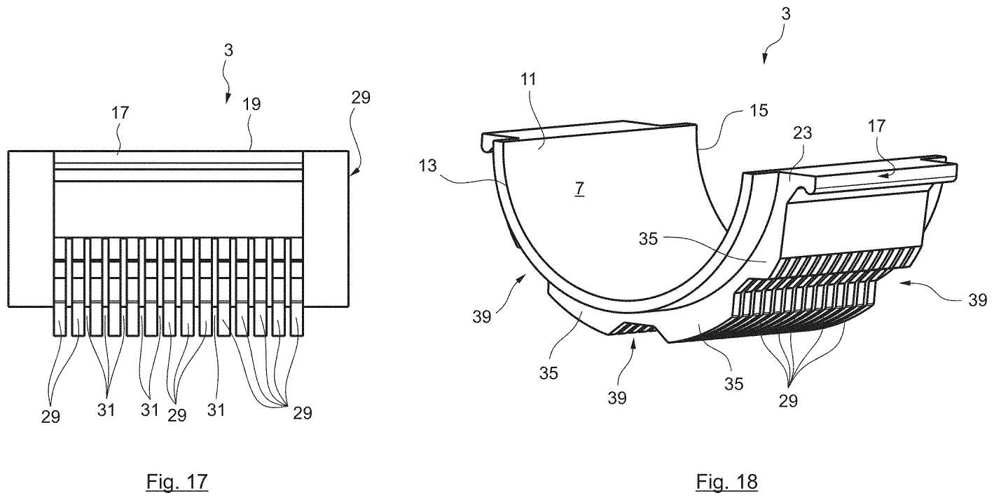

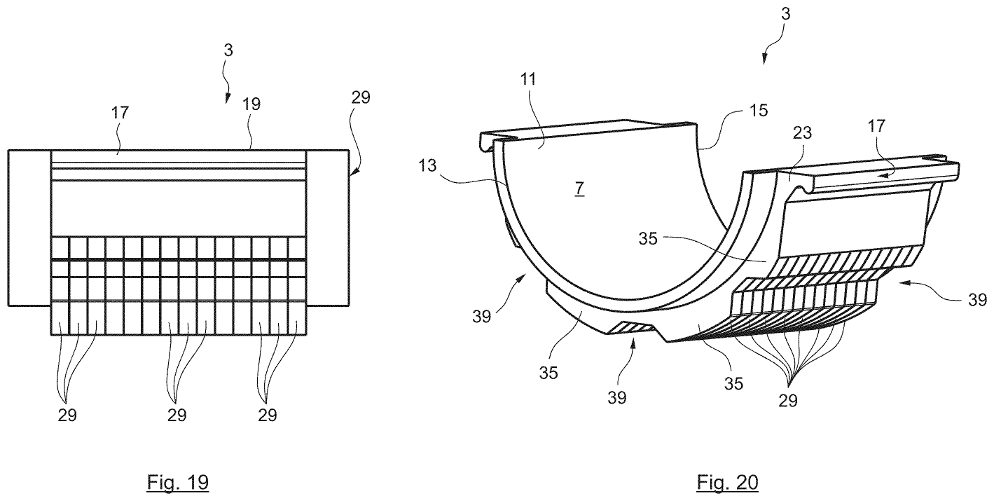

With reference to FIGS. 13 to 20, further embodiments of elastomer bushings 1 according to the disclosure are described, wherein the same or similar components as in FIGS. 1 to 9 are designated and provided with the same or similar reference signs. Briefly, the embodiment of the elastomer bushing half-shell 3, 3′ of FIGS. 13 and 14 is characterized by a longitudinally varying radial height of the support webs 29, 41, that of FIGS. 15 and 16 by a longitudinally varying axial dimension of the support webs 29, 41 and the recesses 37, 39, that of FIGS. 17 and 18 by a lamellar structure, and that of FIGS. 19 and 20 by a slot structure.

The elastomer bushing 1 of FIGS. 13 and 14 comprises a plurality of support webs 29, 41 which are arranged uniformly distributed in the axial direction and can be divided into 2 groups of support webs of different radial heights. Both centrally with respect to the axial extension and at the edge regions, the support webs 29, 41 are larger in radial direction than intermediate support webs 29, 41.

In the embodiment shown in FIGS. 15 and 16, the support webs 29, 41 are also grouped together. Identical support webs 29, 41 are arranged in a group of three at the edges, while two groups of one thick and one thin support web 29, 41 are arranged intermediately. Large recesses 37, 39 are located between the respective groups.

The elastomer bushing 1 with the lamellar structure of FIGS. 17 and 18 has a regular support web 29, 41 deflection space sequence. The support webs 29, 41 have a dimension in the longitudinal direction in the range from 5 mm to 15 mm. The intervening recesses 37, 39 have a longitudinal dimension in the range of 5 mm to 10 mm.

Finally, the embodiment of the elastomer bushing 1 according to the disclosure illustrated in FIGS. 19 and 20 differs from the preceding embodiments in that the deflection spaces or the recesses 37, 39 are dimensioned so narrowly, in particular are produced by a slit, that mutually facing and longitudinally oriented slit surfaces 53, 55 of each two recesses 37, 39 formed as a slit are in contact with each other.

The features disclosed in the foregoing description, figures, and claims may be significant both individually and in any combination for the realization of the disclosure in the various embodiments.

To enable those skilled in the art to better understand the solution of the present disclosure, the technical solution in the embodiments of the present disclosure is described clearly and completely below in conjunction with the drawings in the embodiments of the present disclosure. Obviously, the embodiments described are only some, not all, of the embodiments of the present disclosure. All other embodiments obtained by those skilled in the art on the basis of the embodiments in the present disclosure without any creative effort should fall within the scope of protection of the present disclosure.

It should be noted that the terms “first”, “second”, etc. in the description, claims and abovementioned drawings of the present disclosure are used to distinguish between similar objects, but not necessarily used to describe a specific order or sequence. It should be understood that data used in this way can be interchanged as appropriate so that the embodiments of the present disclosure described here can be implemented in an order other than those shown or described here. In addition, the terms “comprise” and “have” and any variants thereof are intended to cover non-exclusive inclusion. For example, a process, method, system, product or equipment comprising a series of steps or modules or units is not necessarily limited to those steps or modules or units which are clearly listed, but may comprise other steps or modules or units which are not clearly listed or are intrinsic to such processes, methods, products or equipment.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

### REFERENCE LIST

1 elastomer bushing
3 half shell
5 elastic bearing
7 interior
9 axle pin
11 interior wall
13, 15 front opening
17 open end section
19, 21 support surface
23 radial protrusion
25, 27 bearing block part
29 outer support web
30 external axial support web
31 outer perimeter
33 groove
35 outer circumferential support web
37, 39 recess
41 inner support web
42 inside axial support web
43 groove
45 interior circumferential support web
47 recess
49, 51 front side
53, 55 slotted surface
A longitudinal axis
M middle axis
Mi center of a component i

1. An elastomer bushing for an elastic bearing of a drive train component of a wind turbine, comprising:
a first half-shell; and
a second half-shell, each of the first and second half-shells being an elastomer part having a Shore hardness of more than 85 Shore A,
wherein at least one of the first and second half-shells has an axial rigidity which varies in a direction of its longitudinal axis.

2. The elastomer bushing according to claim 1, wherein at least one of the first and second half-shells comprises polyurethane-polyester or polyester-urethane rubber.

3. The elastomer bushing according to claim 1, wherein the first and second half-shells each have a central axis which are oriented concentrically to one another in an operating state in the elastic bearing when the first and second half-shells rest on one another and/or the elastic bearing is in an assembled state.

4. The elastomer bushing according to claim 1, wherein the elastomer bushing has a radial rigidity transverse to the longitudinal axis that is greater than its axial rigidity in the longitudinal axis direction, the axial rigidity being less than 10% of the radial rigidity.

5. An elastomer busing for an elastic bearing of a drive train component of a wind turbine, comprising:
a first half-shell; and
a second half-shell, each of the first and second half-shells being an elastomer part with a Shore hardness of more than 85 Shore A,
wherein at least one of the first and second half-shells has a varying axial rigidity and includes at least two support webs arranged at a distance from one another in a longitudinal direction and/or transversely thereto, the at least two support webs project from an outer circumference or inner circumference of the at least one of the first and second half-shells such that a deflection space is formed between the at least two support webs.

6. The elastomer busing according to claim 5, wherein the at least two support webs are arranged to yield in the longitudinal direction and/or transversely thereto into an adjacent yielding space, in the longitudinal direction and/or transversely thereto, in response to a load being applied onto the elastomer bushing.

7. The elastomer busing according to claim 5, wherein the at least two support webs are rectangular in cross-section or have a conical shape and/or taper in the radial direction.

8. The elastomer busing according to claim 5, wherein one or more of the at least two webs is segmented in a circumferential direction to form at least two circumferential support webs, wherein two respectively adjacent circumferential support webs are separated from each other in the circumferential direction by a recess.

9. The elastomer bushing according to claim 8, wherein the at least two circumferential support webs are arranged to deflect into the adjacent recess in the circumferential direction in response to a load being applied onto the elastomeric bushing.

10. The elastomer busing according to claim 5, wherein at least one of the first and second half-shells includes an anti-rotation device, which is realized by pinning, gluing or through a radial projection cooperating with a bearing block part of the bearing.

11. The elastomer bushing according to claim 10, wherein the first and second half-shells each have a c-shaped cross-section, and the radial projection being arranged in an open end of the c-shaped cross-section.

12. The elastomer busing according to claim 5, wherein at least one of the first and second half-shells has a radial rigidity varying transversely to the longitudinal axis.

13. The elastomer busing according to claim 12, wherein the at least two support webs have a radial height varying in the circumferential direction and/or longitudinal direction, and wherein the radial height of the at least two support webs decreases towards an open end portion of the respective half-shell.

14. The elastomer busing according to claim 5, wherein the at least two support webs have a recess in a vertex of the respective c-shaped half-shells.

15. The elastomer busing according to claim 5, wherein one of the first and second half-shells has a greater radial rigidity transverse to the longitudinal axis than the other of the first and second half-shells.

16. The elastomer busing according to claim 5, wherein an axial dimension of the deflection space and/or the at least two support webs varies with respect to the longitudinal direction.

17. The elastomer busing according to claim 5, wherein a sequence of the at least two support webs and deflection space sequence comprises at least three, support webs, wherein the at least three support webs are uniformly arranged in the longitudinal direction and are lamellar.

18. The elastomer busing according to claim 5, wherein at least one of the first and second half-shells includes slits on its outer circumference, the slits being uniformly distributed in the longitudinal direction and/or are dimensioned such that: mutually facing and longitudinally oriented slit surfaces of two respective elastomer part webs of the at least two support webs separated by a slit are in contact with one another in an undeformed state of the elastomer bushing, and/or the deflection space is dimensioned in the longitudinal direction such that two respectively adjacent support webs of the at least two support webs are in contact with one another in an undeformed state of the elastomer bushing.

19. An elastic bearing for mounting a drive train component of a wind turbine, comprising:
the elastomer bushing according to claim 5, and
two bearing block parts configure to clampingly receive the elastomer bushing.

20. An elastic bearing for mounting a drive train component of a wind turbine, comprising:
an elastomer bushing including two half-shells, being an elastomer part with a Shore hardness of more than 85 Shore A, and
two bearing block parts configured to jammingly receive the elastomer bushing,
wherein the elastomer bushing is configured such that an axial movement clearance of the elastomer bushing in a direction of its longitudinal axis relative to the two bearing block parts or relative to a fastening part received by the elastomer bushing permitted in response to a load being applied in the longitudinal direction onto the elastic bearing, and
wherein the axial movement clearance is at least 1 mm and at most 50 mm.
